(19) United States
(12) Patent Application Publication
(10) Pub. No.: US 2015/0183140 A1
(43) Pub. Date: Jul. 2, 2015

(54) FOAM GRIP FABRICATION METHOD

(71) Applicant: FEELTECGRIP INC., Dacun Township (TW)

(72) Inventor: Chi-Hua SUN, Dacun Township (TW)

(73) Assignee: FEELTECGRIP INC., Dacun Township (TW)

(21) Appl. No.: 14/289,020

(22) Filed: May 28, 2014

(30) Foreign Application Priority Data
Dec. 31, 2013 (TW) 102149356

(51) Int. Cl. B29C 44/02; B29C 44/58; B29C 44/34

(52) U.S. Cl. CPC B29C 44/027; B29C 44/3403; B29C 44/3415; B29C 44/583

(57) ABSTRACT

A foam grip fabrication method includes a mold preparation step to prepare a foaming mold having a size reduced to a predetermined foaming ratio, a heating step to heat the foaming mold to a bridging curve temperature, and then to close the foaming mold and to draw the foaming mold to a negative pressure state, a material filling step to mix a raw material to be foamed with a foaming agent and a crosslinking agent and then to inject the foaming material thus obtained into the foaming mold, and a foaming step to open the foaming mold after vulcanization of the molding for enabling a flow of outside air to enter and to cause the molding thus molded to expand and then to put the molding on a tool for cooling and shaping so that a finished product in the desired size is thus obtained.

### BACKGROUND OF THE INVENTION

1. Field of the Invention The present invention relates to technology and more particularly, to a foam grip fabrication method for making foam grips.

2. Description of the Related Art

Foam grip fabrication methods can be classified in two types, namely, the in-mold foaming method and the out-mold foaming method. An out-mold foaming method is to make a foam grip by molding a planar or cylindrical molding on the outside of a mold and then employing an external carving technique to shape the molding into a finished product. This method is complicated and time-consuming, and difficult to accurately control the size. An in-mold foaming method has a limitation on the applied material, normally, a fluid foaming material is applied for foaming. A foam grip made by in-mold foaming is difficult to achieve the desired strength and touch sensation. Further, when a foam grip is shape-formed in the foam mold cavity by in-mold foaming, the foam grip will provide an open cell surface structure that can absorb water, and has a poor outer looking, low structural strength and other drawbacks.

Therefore, it is desirable to provide a foam grip fabrication method that eliminates the drawbacks of conventional techniques.

### SUMMARY OF THE INVENTION

The present invention has been accomplished under the circumstances in view. It is the main object of the present invention to provide a foam grip fabrication method, which shortens foam grip fabrication time, increases the productivity, improves product surface structure, assures foam grip size accuracy, and provides excellent foam grip surface quality.

To achieve this and other objects of the present invention, a foam grip fabrication method for making a foam grip having an axial hole comprises a mold preparation step to prepare a foaming mold having a size reduced to a predetermined foaming ratio, i.e., the size of the design foam grip divided by the foaming ratio=the size of the foaming mold, wherein the foaming mold comprises a foam mold cavity and a rapping rod extended to the foam mold cavity; a heating step to heat the foaming mold to a bridging curve temperature for foaming, and then to close the foaming mold and to draw the foaming mold to a negative pressure state; a material filling step to mix a raw material to be foamed with a foaming agent and a crosslinking agent so as to obtain a foaming material, and then to inject the foaming material into the foaming mold for foaming; and a foaming step to let the foaming material be vulcanized into a molding having an axial bore, and then to open the foaming mold for enabling a flow of outside air to enter the foaming mold and to cause the molding thus molded to expand, and then to put the molding on a tool for cooling and shaping so that a finished product in the desired size is thus obtained.

Thus, the foam grip fabrication method of the present invention is different from conventional plastic or rubber injection molding techniques and conventional in-mold foaming and out-mold foaming techniques. The invention simplifies the fabrication procedure and adding an outer appearance design to the finished product. The foam grip fabrication method of the invention is practical for fabricating foam grips conveniently and rapidly in a mass production manner, eliminating further grinding and other follow-up steps, and the products thus made have a smooth surface and precise size. Therefore, the invention, effectively shortens foam grip fabrication time, increases the foam grip productivity, assures foam grip size accuracy, and provides excellent foam grip surface properties.

Further, unlike the conventional out-mold foaming type foam grip fabrication method for making a foam grip by molding a foam tube on the outside of a mold and then employing an external carving technique to shape the foam tube into a finished product, the invention simplifies the fabrication procedure and adds an outer appearance design to the finished product.

Further, the invention is practical for making foam grips for golf club, tennis racket, ball game grip, trekking pole and hand cane applications

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a foam grip made according to the present invention.

FIG. 2 is a schematic sectional view of a foaming mold for the fabrication of a foam grip in accordance with the present invention.

FIG. 3 is a schematic drawing illustrating a foam grip fabrication procedure in accordance with the present invention (I).

FIG. 4 is a schematic drawing illustrating a foam grip fabrication procedure in accordance with the present invention (II).

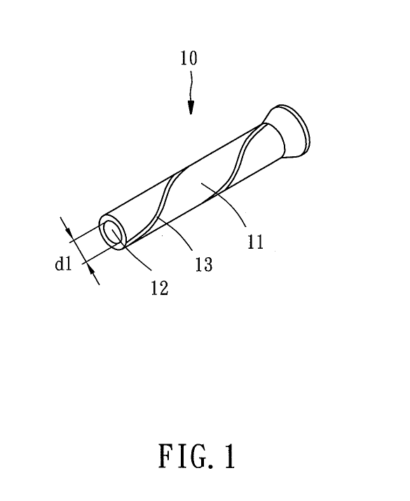

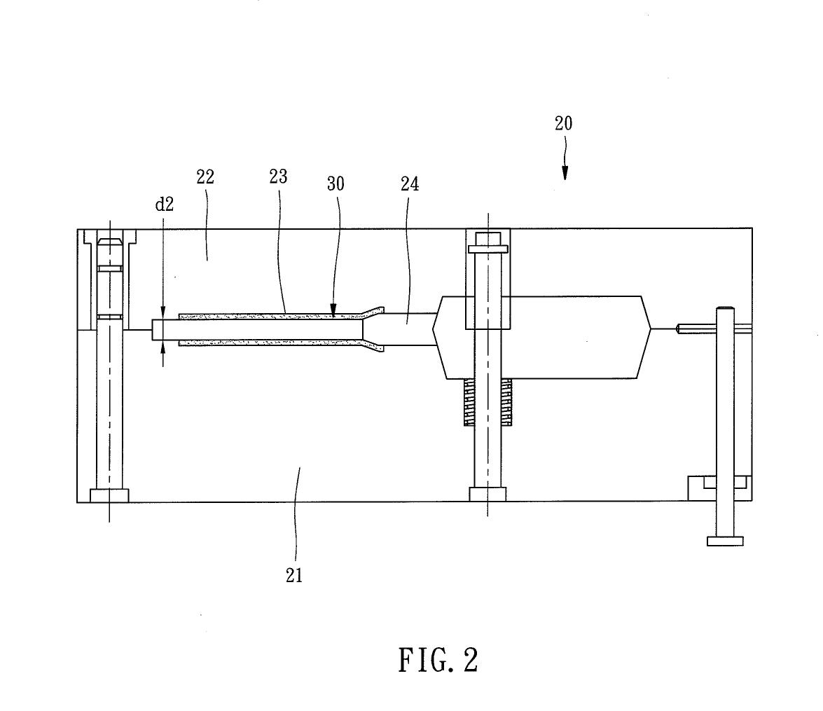

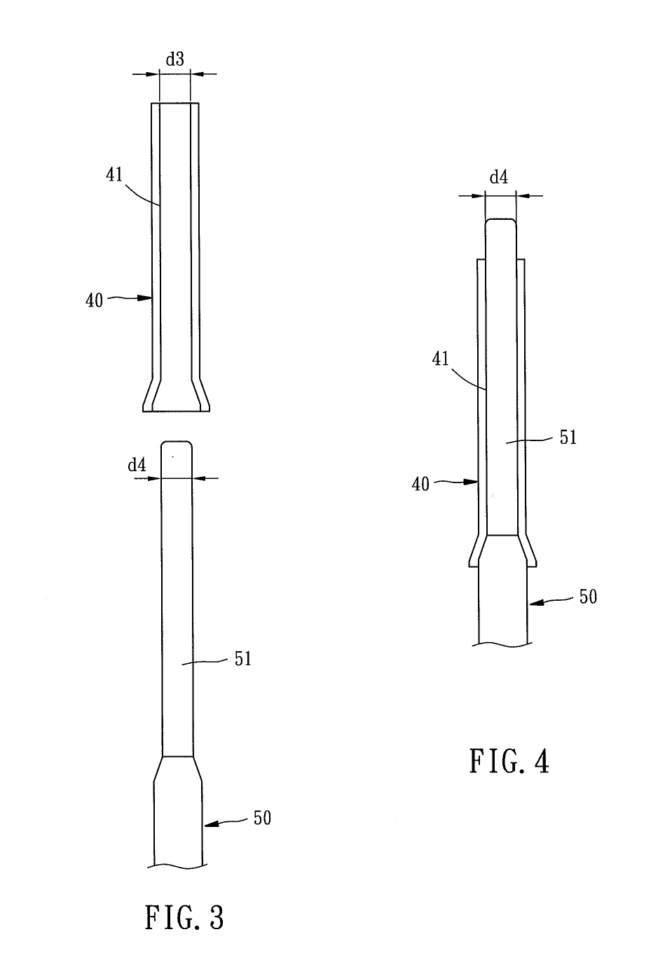

### DETAILED DESCRIPTION OF THE INVENTION

Referring to the annexed drawings in detail, the present invention provides a foam grip fabrication method for making a foam grip 10 comprising a grip body 11, an axial hole 12 axially extending through the grip body 11 and having a bore diameter dl, and a design 13 made in the form of an anti-slip pattern, trademark or ditch line at the periphery of the grip body 11. The foam grip fabrication method includes the steps of:

Mold preparation step: where a foaming mold 20 having a size reduced to a predetermined foaming ratio, i.e., the size of the design foam grip divided by the foaming ratio=the size of the foaming mold 20, wherein the foaming mold 20 comprises a first mold half 21, a second mold half 22 detachably closed on the first mold half 21, a foam mold cavity 23 defined in between the first mold half 21 and the second mold half 22 and having a size smaller than the size of the foam grip to be made, and a rapping rod 24 extended to the foam mold cavity 23 and having an outer diameter d2 smaller than the bore diameter d1 of the axial hole 12; a trademark, ditch line or anti-slip pattern is directly formed in the foaming mold 20 in a size proportional to the downscaling of the foaming mold 20.

Heating step: where the foaming mold 20 is heated to a bridging curve temperature in the range of, for example, 145° C.˜180° C. for foaming, and then the foaming mold 20 is closed and the internal pressure of the foaming mold 20 is drawn out to a negative pressure state.

Material filling step: where a raw material selected from the group of thermoplastic polyurethane (TPU), thermoplastic rubber (TPR), ethylene vinyl acetate (EVA), rubber, silicone rubber, and mixtures thereof, is mixed with a foaming agent and a crosslinking agent to provide a foaming material 30, and then the foaming material 30 is injected into the foaming mold 20 for foaming.

Foaming step: where the applied foaming material 30 is vulcanized, and then the foaming mold 20 is opened, enabling the molding 40 thus molded to expand subject to the effect of intake flow of outside air, and then the molding 40 is put on a tool 50 and cooled down and shaped, and a finished product in the desired size is thus obtained.

Further, the molding 40 has an axial bore 41 defining a bore diameter d3. Further, the tool 50 has a tool rod 51 corresponding to the axial bore 41 of the molding 40. The outer diameter d4 of the tool rod 51 is equal to the bore diameter d1, i.e., the bore diameter d3 of the molding 40 is slightly larger than the outer diameter d4 of the tool rod 51.

Thus, by means of controlling the foaming ratio to match with the designed size of the foaming mold 20 and the designed foaming step, the molding 40 thus molded is taken out of the foaming mold 20 and put on the tool 50, enabling a finished product in the desired size to be rapidly and accurately obtained, shortening the mold closing and injection time.

The foam grip thus made has shock absorbing and comfort touch characteristics. Further, the out-mold foaming process of the present invention enables a close cell structure to be formed in the surface of the finished product that repels water, and thus, the anti-slip characteristic of the foaming material 30 in a dry state is maintained.

Although a particular embodiment of the invention has been described in detail for purposes of illustration, various modifications and enhancements may be made thereunto without departing from the spirit and scope of the invention.

For example, the heating temperature in the heating step, instead of 145° C.˜180° C., can be 145° C.˜160° C., or 150° C.˜170° C., or 160° C.˜180° C.

Further, the anti-slip pattern, trademark or ditch line can be painted and then dried, and then the surface area around the anti-slip pattern, trademark or ditch line is sanded to provide a porous surface structure, maintaining the paint in the grooved anti-slip pattern, trademark or ditch line and increasing the coefficient of friction and pleochroism of the product.

Further, the foam grip can be formed of two or three component parts, i.e., front tip, grip body and rear end cap, where the grip body is a foam structure made according to the aforesaid foam grip fabrication method; the front tip and the rear end cap made of different materials having different hardness. A foam grip of this design has a better structural strength.

Further, the foam grip has opposing first end and second end aligned in the longitudinal direction. A first end positioning member (not shown) and a second end positioning member (not shown) are provided in the foaming step for the positioning of the opposing first end and second end of the molding thus molded.

In general, the invention provides a foam grip fabrication method, which is practical for fabricating foam grips conveniently and rapidly in a mass production manner, eliminating further grinding and other follow-up steps, and the products thus made have a smooth surface and precise size. Therefore, the invention achieves the expected objects, i.e., effectively shortens foam grip fabrication time, increases the foam grip productivity, assures foam grip size accuracy, and provides excellent foam grip surface properties.

Further, the foam grip fabrication method is different from the traditional plastic or rubber injection molding and in-mold foaming techniques. Unlike the conventional out-mold foaming type foam grip fabrication method for making a foam grip by molding a foam tube on the outside of a mold and then employing an external carving technique to shape the foam tube into a finished product, the invention simplifies the fabrication procedure and adds an outer appearance design to the finished product.

What is claimed is:

1. A foam grip fabrication method for making a foam grip (10) having an axial hole (12), the method comprising:
a mold preparation step to prepare a foaming mold (20) having a size reduced to a predetermined foaming ratio, i.e., the size of the design foam grip divided by the foaming ratio =the size of the foaming mold (20), said foaming mold (20) comprising a foam mold cavity (23) and a rapping rod (24) extended to said foam mold cavity (23);
a heating step to heat said foaming mold (20) to a bridging curve temperature for foaming, and then to close said foaming mold (20) and to draw said foaming mold (20) to a negative pressure state;
a material filling step to mix a raw material to be foamed with a foaming agent and a crosslinking agent so as to obtain a foaming material (30), and then to inject said foaming material (30) into said foaming mold (20) for foaming; and
a foaming step to let said foaming material (30) be vulcanized into a molding (40) having an axial bore (41), and then to open said foaming mold (20) for enabling a flow of outside air to enter said foaming mold (20) and to cause the molding (40) thus molded to expand, and then to put said molding (40) on a tool (50) for cooling and shaping so that a finished product in the desired size is thus obtained.

2. The foam grip fabrication method as claimed in claim 1, wherein said mold preparation step comprises a sub-step of making a trademark, ditch line or anti-slip pattern on said foaming mold (20), enabling said molding (40) to provide trademark, ditch line or anti-slip pattern on the surface thereof.

3. The foam grip fabrication method as claimed in claim 2, further comprising a sub step of coating a paint on the surface area of the trademark, ditch line or anti-slip pattern of said molding (40).

4. The foam grip fabrication method as claimed in claim 3, further comprising a sub step of sanding the surface area of trademark, ditch line or anti-slip pattern of said molding (40).

5. The foam grip fabrication method as claimed in claim 4, wherein said bridging curve temperature is in the range of 145° C.˜180° C.

6. The foam grip fabrication method as claimed in claim 5, wherein said tool (50) used in said foaming step comprises a tool rod (51) insertable into said axial bore (41) of said molding (40).

7. The foam grip fabrication method as claimed in claim 6, wherein said tool rod (51) is configured in a proportionally enlarged scale relative to the configuration of said rapping rod (24).

8. The foam grip fabrication method as claimed in claim 2, wherein said bridging curve temperature is in the range of 145° C.˜180° C.

9. The foam grip fabrication method as claimed in claim 8, wherein said tool (50) used in said foaming step comprises a tool rod (51) insertable into said axial bore (41) of said molding (40).

10. The foam grip fabrication method as claimed in claim 9, wherein said tool rod (51) is configured in a proportionally enlarged scale relative to the configuration of said rapping rod (24).

11. The foam grip fabrication method as claimed in claim 2, wherein said tool (50) used in said foaming step comprises a tool rod (51) insertable into said axial bore (41) of said molding (40).

12. The foam grip fabrication method as claimed in claim 11, wherein said tool rod (51) is configured in a proportionally enlarged scale relative to the configuration of said rapping rod (24).

13. The foam grip fabrication method as claimed in claim 2, wherein the scaling of the trademark, ditch line or anti-slip pattern in said foaming mold (20) is determined subject to said predetermined foaming ratio.

14. The foam grip fabrication method as claimed in claim 1, wherein said raw material used in said material filling step is selected from the group of thermoplastic polyurethane (TPU), thermoplastic rubber (TPR), ethylene vinyl acetate (EVA), rubber, silicone rubber and mixtures thereof.

15. The foam grip fabrication method as claimed in claim 1, wherein said bridging curve temperature is in the range of 145° C.˜180° C.

16. The foam grip fabrication method as claimed in claim 1, wherein said tool (50) used in said foaming step comprises a tool rod (51) insertable into said axial bore (41) of said molding (40).

17. The foam grip fabrication method as claimed in claim 16, wherein said tool rod (51) is configured in a proportionally enlarged scale relative to the configuration of said rapping rod (24).

18. The foam grip fabrication method as claimed in claim 1, wherein said foam grip (10) comprises opposing first end and second end; said foaming step further comprises a sub step of providing a first end positioning member and a second end positioning member for the positioning of opposing first end and second end of the molding being molded.
